(19) United States
(12) Patent Application Publication
(10) Pub. No.: US 2017/0074461 A1
(43) Pub. Date: Mar. 16, 2017

(54) LED TUBE

(71) Applicant: HSU LI YEN, TAIPEI COUNTY (TW)

(72) Inventor: HSU LI YEN, TAIPEI COUNTY (TW)

(21) Appl. No.: 14/856,185

(22) Filed: Sep. 16, 2015

(51) Int. Cl. F21K 99/00; F21V 15/01; F21V 23/06; F21V 19/00; F21V 29/74

(52) U.S. Cl. CPC F21K 9/17; F21V 19/009; F21V 29/74; F21V 23/06; F21V 15/01; F21Y 2103/003

(57) ABSTRACT

A connector locking base structure of an LED lamp includes a connector locking base having a conventional lamp connector and a locking base coupled together such that a threaded end of a cap of the LED lamp can be screwed to the locking base of the connector locking base. The conventional lamp connector of the connector locking base can be inserted into a socket for use with a conventional lamp, thereby allowing power to be supplied to the LED lamp for emission of light. Grooves formed in a casing of the conventional lamp connector are engaged with hooks of the locking base. A screw hole is centrally formed in the locking base. The hooks are provided on the inner side of the locking base and engaged with the grooves of the conventional lamp connector, respectively, to thereby form the connector locking base.

### BACKGROUND OF THE INVENTION

1. Technical Field

The present invention relates to LED tubes, and more particularly to an LED tube which features high strength of its tubular housing, quick heat dissipation and easy assembly.

2. Description of Related Art

The traditional LED tubes usually have a tubular housing made as a plastic thin tubular body with a velvet surface for an LED plate to position therein. Such a tubular housing is relatively insufficient in terms of strength. Some other LED tubes have tubular housing composed of a semi-circular cylinder made from a thing aluminum sheet and a semi-circular cylinder made from a thing plastic sheet, velvet-surface plastic sheet and are thus stronger than the traditional ones. However, manufacturing of such LED tubes requires more costs and is more labor- and time-consuming.

In addition, in the existing approach, connector seats having conductive terminals are fastened at two ends of the tubular housing with manually screwed bolts, so the assembly is difficult to be efficient.

In view of the shortcomings of the prior art, the inventor of the present invention uses his years of experience in the industry to do research and finally develops an advanced structure for the subject matter.

### SUMMARY OF THE INVENTION

The present invention hence provides an LED tube featuring high strength of its tubular housing, quick heat dissipation and easy assembly.

The disclosed LED tube comprises:
a tubular housing being tubular body that has a flat portion on which a plurality of ribs is formed, the tubular housing having mortises formed near two ends of the flat portion, and tubular housing having two L-shaped opposite rails that are formed at a bottom of the flat portion and thus located inside the tubular body for an LED plate to insert there between and thereby get positioned; and
two connector seats incorporating conductive terminals, each of the connector seats having a C-shaped bush and a tongue provided with a tenon; whereby when the two connector seats have the bushes and the tongues thereof inserted into two ends of the tubular housing, the tenons on the tongues are engaged with the mortises formed near the two ends of the flat portion of the tubular housing, so as to form the LED tube.

### BRIEF DESCRIPTION OF THE DRAWINGS

FIG. 1 is an exploded view of an LED tube of the present invention;

FIG. 1A is a partial, enlarged view of FIG. 1;

FIG. 2 is a perspective view of the LED tube of FIG. 1;

FIG. 2A is a partial, enlarged view of FIG. 2; and

FIG. 3 is a cutaway diagram of the LED tube cut along Line A-A of FIG. 2

### DETAILED DESCRIPTION OF THE INVENTION

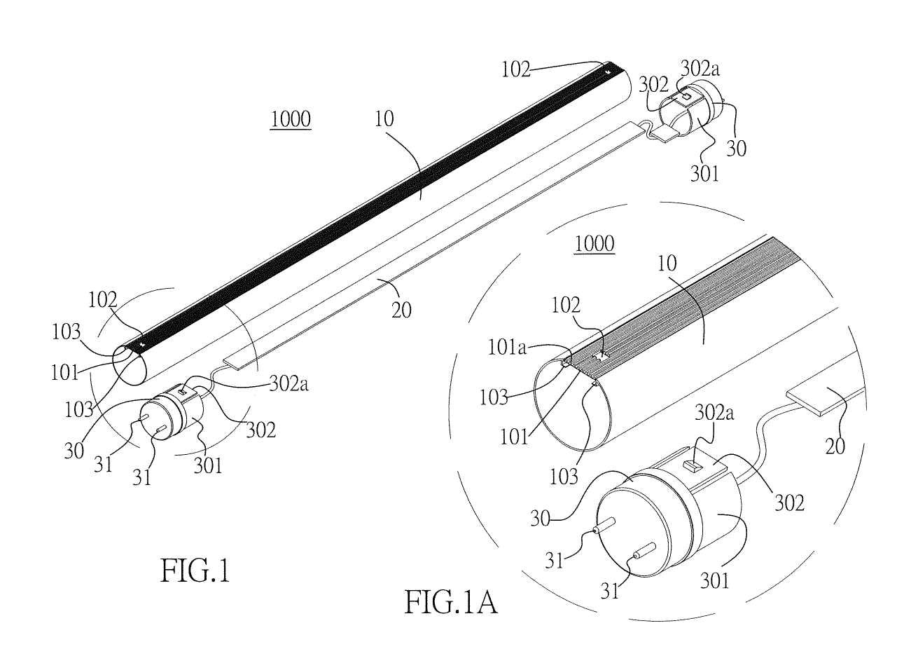

An LED tube as disclosed in the present invention is shown in the exploded views of FIG. 1. Referring to FIG. 1A, the LED tube 1000 comprises a tubular housing 10, an LED plate 20, and two connector seats 30.

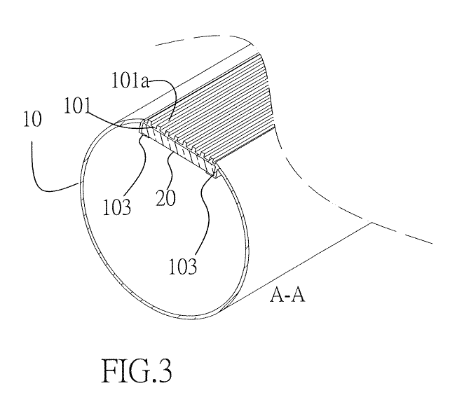

The tubular housing 10, as also shown in FIG. 3, is a tubular body having a flat portion 101. Plural ribs 101a are formed on the flat portion 101 for increasing the strength of the tubular housing 10. The tubular housing 10 has two mortises 102 formed near two ends of the flat portion 101, respectively. In addition, there are two L-shaped opposite rails 103 formed at the bottom of the flat portion 101 and are thus located inside the tubular housing 10, for the LED plate 20 to insert there between and get positioned.

In use, the heat generated by the activated LED plate 20 can be transferred to the flat portion 101 and the ribs 101a of the tubular housing 10 so as to be dissipated rapidly.

The two connector seats 30 incorporate conductive terminals 31. Each of the connector seats 30 has a C-shaped bush 301 and a tongue 302 that includes a tenon 302a.

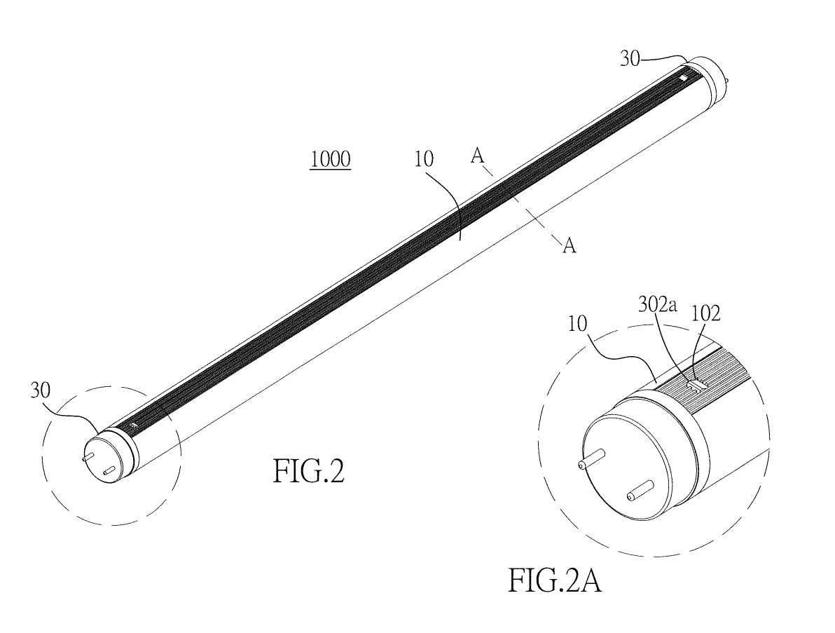

When the two connector seats 30, also seen in FIG. 2 and FIG. 2A, have their bushes 301 and tongues 302 properly inserted two ends of the tubular housing 10, the tenons 302a on the tongues 302 are engaged with the mortises 102 formed near the two ends of the flat portion 101 of the tubular housing 10, so that the connector seats 30 and the tubular housing 10 are combined readily and firmly to form the LED tube 1000.

To sum up, the present invention is truly effective in achieving the desired functions, and has not been seen in public use. This application is thus filed for patent protection.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. An LED tube comprising:
a tubular housing being tubular body that has a flat portion on which a plurality of ribs is formed, the tubular housing having mortises formed near two ends of the flat portion, and tubular housing having two L-shaped opposite rails that are formed at a bottom of the flat portion and thus located inside the tubular body for an LED plate to insert there between and thereby get positioned; and
two connector seats incorporating conductive terminals, each of the connector seats having a C-shaped bush and a tongue provided with a tenon;
whereby when the two connector seats have the bushes and the tongues thereof inserted into two ends of the tubular housing, the tenons on the tongues are engaged with the mortises formed near the two ends of the flat portion of the tubular housing, so as to form the LED tube.
